(19) United States
(12) Patent Application Publication
(10) Pub. No.: US 2025/0178900 A1
(43) Pub. Date: Jun. 5, 2025

(54) METHOD FOR MICROWAVE-ENHANCED CARBON REDUCTION OF WASTE SULFURIC ACID

(71) Applicant: INSTITUTE OF PROCESS ENGINEERING, CAS, Beijing (CN)

(72) Inventors: Zhimao ZHOU, Beijing (CN); Shifei LI, Beijing (CN)

(21) Appl. No.: 18/945,873

(22) Filed: Nov. 13, 2024

Related U.S. Application Data
(63) Continuation of application No. PCT/CN2023/091987, filed on May 4, 2023.

(30) Foreign Application Priority Data
May 13, 2022 (CN) 202210522237.0

(51) Int. Cl. C01B 17/50; B01D 53/00; B01D 53/14

(52) U.S. Cl. CPC C01B 17/503; B01D 53/002; B01D 53/1481; B01D 2257/302; C01P 2006/80

(57) ABSTRACT

A method for microwave-enhanced carbon reduction of waste sulfuric acid is provided, including the following steps: (1) immersing a carbon material with waste sulfuric acid to obtain a mixture; and (2) subjecting the mixture to microwave heating to allow a reaction to obtain a sulfur dioxide gas and sulfonated carbon.

### TECHNICAL FIELD

The present disclosure belongs to the technical field of waste resource utilization, such as a method for carbon reduction of waste sulfuric acid, specifically a method for microwave-enhanced carbon reduction of waste sulfuric acid.

### BACKGROUND

As an important basic chemical product, sulfuric acid is consumed in huge quantities and is widely used in industrial and agricultural production. Except for a small amount of sulfur transferred to products such as ammonium sulfate, magnesium sulfate, or aluminum sulfate, most of the sulfur is produced in the form of industrial waste gypsum, sodium sulfate, or waste sulfuric acid. Waste sulfuric acid is both a hazardous waste that is difficult to treat and a potential sulfur resource. Converting the waste sulfuric acid into sulfur dioxide or sulfur is the main way to realize the resource utilization of waste sulfuric acid.

CN106315520A has disclosed an improved cracking process of waste sulfuric acid. The waste sulfuric acid, air, and fuel that provides the heat required for cracking are used as raw materials, the waste sulfuric acid undergoes a cracking reaction in a cracking furnace to generate a mixed furnace gas containing sulfur dioxide, sulfur trioxide, carbon dioxide, water vapor, nitrogen, and smoke. The mixed furnace gas enters a subsequent acid production system after heat exchange to produce finished sulfuric acid. However, the cracking furnace is above 600° C. inside, making the reaction temperature high, and requires external fuel to provide heat, making the operating cost high.

CN109052335A has disclosed a method for reducing waste sulfuric acid with sulfur gas to produce liquid sulfur dioxide and sulfuric acid. The sulfur is gasified into high-temperature sulfur gas, and the raw waste sulfuric acid is washed, evaporated, concentrated, and cracked into a gas. The two gases react in a reduction furnace to generate sulfur dioxide gas, while organic impurities in the waste sulfuric acid can also be removed. One part of the sulfur dioxide is liquefied to produce a high-purity liquid sulfur dioxide product, and the other part of the sulfur dioxide can be converted and absorbed to produce concentrated sulfuric acid. CN109437118A has disclosed a method and a device for treating industrial waste sulfuric acid to recover sulfur. The device includes a high-temperature decomposition furnace, a reaction gas heat exchange device, a carbon thermal reduction tower, an exhaust gas cooling device, and a desulfurization tower. The method realizes the recovery of waste sulfuric acid to obtain sulfur, realizes the full utilization of heat energy and products, and reduces the cost of recycling. The methods for treating waste sulfuric acid in the above patents have the shortcomings of complex operation, numerous steps, and still high cracking temperature.

CN101200288A has disclosed a method for regenerating waste sulfuric acid. The method includes decomposing waste sulfuric acid into sulfur dioxide in the presence of a hydrocarbon reducing agent, where the hydrocarbon reducing agent is a hydrocarbon contaminant, preferably a film on a solid surface. The sulfur dioxide produced in the decomposition is converted into sulfur trioxide in the presence of water and concentrated sulfuric acid is condensed. However, a process of producing sulfur dioxide by the reaction of sulfuric acid and carbon is complicated and accompanied by various side reactions. This method does not control these side reactions, which may have an adverse effect on the resource utilization of sulfur.

In view of the shortcomings of the related art, it is necessary to provide a method for treating waste sulfuric acid with simple operation, low energy consumption, and high product yield.

### SUMMARY

An overview of the subject matter detailed in the present disclosure is provided below, which is not intended to limit the protection scope of the claims.

The present disclosure provides a method for microwave-enhanced carbon reduction of waste sulfuric acid. The method controls a reaction temperature of carbon and waste sulfuric acid by indirect heating through microwave radiation, thereby effectively improving a reaction efficiency. The method has few reaction steps, low energy consumption, and high yield of reaction products, ultimately achieving low-cost resource utilization of the waste sulfuric acid.

The present application adopts the following technical solutions.

The present disclosure provides a method for microwave-enhanced carbon reduction of waste sulfuric acid, including the following steps:
(1) immersing a carbon material with waste sulfuric acid to obtain a mixture; and
(2) subjecting the mixture obtained in step (1) to microwave heating to allow a reaction to obtain a sulfur dioxide gas and sulfonated carbon. In the method for microwave-enhanced carbon reduction of waste sulfuric acid provided in the example of the present disclosure, the carbon material and the waste sulfuric acid are fully mixed, and the waste sulfuric acid is evenly distributed on a surface of the carbon material. Under microwave radiation heating, the carbon material absorbs microwaves, and the temperature rises evenly to promote the reaction. At the same time, the waste sulfuric acid also absorbs microwaves to accelerate the decomposition of sulfuric acid molecules. Compared with conventional heating, microwave irradiation heating can significantly increase a reaction rate and increase a yield of the reaction product.

In an example, the carbon material in step (1) includes any one of coal, biomass, activated carbon, resin, sulfonated carbon, biochar, waste activated carbon, or waste resin, or a combination of two or more thereof. Typical but non-limiting combinations include a combination of coal and biomass, a combination of activated carbon and resin, a combination of sulfonated carbon and biochar, a combination of waste activated carbon and waste resin, a combination of coal, biomass, and activated carbon, a combination of resin, sulfonated carbon, and biochar, a combination of coal, biomass, activated carbon, and resin, a combination of resin, sulfonated carbon, biochar, waste activated carbon, and waste resin, a combination of coal, biomass, activated carbon, resin, sulfonated carbon, and biochar, a combination of biomass, activated carbon, resin, sulfonated carbon, biochar, waste activated carbon, and waste resin, or a combination of coal, biomass, activated carbon, resin, sulfonated carbon, biochar, waste activated carbon, and waste resin.

The biomass includes any one of date pits, walnut shells, pecan shells, waste tea leaves, corn cobs, coconut shells, beetroots, peanut shells, rice husks, cotton husks, banana peels, bamboo waste, olive pits, cherry pits, orange peels, coffee pods, corn stalks, reed stalks, vegetable stalks, or cassava peels, or a combination of two or more thereof.

In an example, the waste sulfuric acid in step (1) includes any one of alkylated waste sulfuric acid, sulfonated waste sulfuric acid, nitrated waste sulfuric acid, or fluorine-containing waste sulfuric acid, or a combination of two or more thereof. Typical but non-limiting combinations include a combination of alkylated waste sulfuric acid and sulfonated waste sulfuric acid, a combination of nitrated waste sulfuric acid and fluorine-containing waste sulfuric acid, a combination of alkylated waste sulfuric acid, sulfonated waste sulfuric acid, and nitrated waste sulfuric acid, or a combination of alkylated waste sulfuric acid, sulfonated waste sulfuric acid, nitrated waste sulfuric acid, and fluorine-containing waste sulfuric acid.

In an example, the carbon material in step (1) is obtained by pretreatment with a mixture of an alkali and a carbonate.

Pretreatment of the carbon material can remove surface impurities and change its specific surface area and pore structure to a certain extent, thereby improving a reaction effect with waste sulfuric acid.

In an example, the mixture of the alkali and the carbonate includes a mixture of sodium hydroxide and sodium carbonate.

In an example, the sodium hydroxide in the mixed solution has a mass fraction of 1.5 wt % to 2.5 wt %, for example, 1.5 wt %, 2 wt %, or 2.5 wt %, but is not limited to the listed values, and other unlisted values within the numerical range are also applicable.

In an example, the sodium carbonate in the mixed solution has a mass fraction of 0.5 wt % to 1.5 wt %, for example, 0.5 wt %, 1 wt %, or 1.5 wt %, but is not limited to the listed values, and other unlisted values within the numerical range are also applicable.

In an example, a solvent in the mixed solution includes deionized water.

In an example, the pretreatment is conducted for 0.1 h to 9 h, for example, 0.1 h, 1 h, 2 h, 3 h, 4 h, 5 h, 6 h, 7 h, 8 h, or 9 h, but is not limited to the listed values, and other unlisted values within the numerical range are also applicable.

In an example, the pretreatment is conducted at 30° C. to 90° C., for example, 30° C., 40° C., 50° C., 60° C., 70° C., 80° C., or 90° C., but is not limited to the listed values, and other unlisted values within the numerical range are also applicable.

In an example, the sulfuric acid in the waste sulfuric acid in step (1) has a mass concentration greater than or equal to 50 wt %, for example, 50 wt %, 60 wt %, 70 wt %, 80 wt %, 90 wt %, or 95 wt %, but is not limited to the listed values, and other unlisted values within the numerical range are also applicable.

In an example, when the waste sulfuric acid is alkylated waste sulfuric acid, the sulfuric acid in the alkylated waste sulfuric acid has a mass concentration greater than or equal to 85 wt %, for example, 85 wt %, 88 wt %, 91 wt %, 92 wt %, or 95 wt %, but is not limited to the listed values, and other unlisted values within the numerical range are also applicable.

In an example, when the waste sulfuric acid is sulfonated waste sulfuric acid, the sulfuric acid in the sulfonated waste sulfuric acid has a mass concentration greater than or equal to 85 wt %, for example, 85 wt %, 88 wt %, 91 wt %, 92 wt %, or 95 wt %, but is not limited to the listed values, and other unlisted values within the numerical range are also applicable.

In an example, the waste sulfuric acid and the carbon material in step (1) are at a mass ratio of (2-20):1, for example, 2:1, 3:1, 5:1, 8:1, 10:1, 12:1, 15:1, 18:1, or 20:1, but are not limited to the listed values, and other unlisted values within the numerical range are also applicable.

In an example, the carbon material in step (1) has a particle size less than or equal to 80 mm, for example, 80 mm, 70 mm, 60 mm, 50 mm, 40 mm, 30 mm, 20 mm, 10 mm, or 5 mm, but is not limited to the listed values, and other unlisted values within the numerical range are also applicable.

In an example, the mixture in step (1) further includes a ceramic absorbing material. The introduction of the ceramic absorbing material having both absorbing and heat storage properties can further improve an efficiency of the reduction reaction.

In the example of the present disclosure, the “mixture further includes a ceramic absorbing material” refers to using waste sulfuric acid to immerse carbon material and ceramic absorbing material to obtain a mixture including the ceramic absorbing material.

In an example, the ceramic absorbing material includes any one of silicon carbide, aluminum oxide, silicon dioxide, silicon nitride, or ferric oxide composite ceramic, or a combination of two or more thereof. Typical but non-limiting combinations include a combination of silicon carbide and silicon nitride, a combination of silicon nitride and ferric oxide composite ceramic, a combination of aluminum oxide and silicon dioxide, a combination of silicon carbide and ferric oxide composite ceramic, a combination of silicon carbide, aluminum oxide, and silicon dioxide, a combination of silicon dioxide, silicon nitride, and ferric oxide composite ceramic, a combination of silicon carbide, aluminum oxide, silicon dioxide, and silicon nitride, or a combination of silicon carbide, aluminum oxide, silicon dioxide, silicon nitride, and ferric oxide composite ceramic.

In an example, the ceramic absorbing material and the carbon material are at a mass ratio of (0.1-10):1, for example, 0.1:1, 1:1, 2:1, 3:1, 4:1, 5:1, 6:1, 7:1, 8:1, 9:1, or 10:1, but are not limited to the listed values, and other unlisted values within the numerical range are also applicable.

In an example, the mixture in step (1) is obtained by separating excess waste sulfuric acid. The waste sulfuric acid is fully wrapped on surfaces of the carbon material and the ceramic absorbing material, and the excess waste sulfuric acid can be separated and reused to reduce resource waste.

In an example, the microwave heating in step (2) includes a first stage, a second stage, and a third stage with temperatures rising sequentially.

In an example, the first stage is conducted at 90° C. to 150° C. for 0.5 h to 3 h.

In an example, the first stage is conducted at 90° C. to 150° C., for example, 90° C., 105° C., 110° C., 120° C., 135° C., 140° C., or 150° C., but is not limited to the listed values, and other unlisted values within the numerical range are also applicable.

In an example, the first stage is conducted for 0.5 h to 3 h, for example, 0.5 h, 1 h, 1.5 h, 2 h, 2.5 h, or 3 h, but is not limited to the listed values, and other unlisted values within the numerical range are also applicable.

In an example, the second stage is conducted at 160° C. to 220° C. for 0.5 h to 3 h.

In an example, the second stage is conducted at 160° C. to 220° C., for example, 160° C., 170° C., 180° C., 190° C., 200° C., 210° C., or 220° C., but is not limited to the listed values, and other unlisted values within the numerical range are also applicable.

In an example, the second stage is conducted for 0.5 h to 3 h, for example, 0.5 h, 1 h, 1.5 h, 2 h, 2.5 h, or 3 h, but is not limited to the listed values, and other unlisted values within the numerical range are also applicable.

In an example, the third stage is conducted at 230° C. to 300° C. for 0.3 h to 2 h.

In an example, the second stage is conducted at 230° C. to 300° C., for example, 230° C., 240° C., 250° C., 260° C., 270° C., 280° C., 290° C., or 300° C., but is not limited to the listed values, and other unlisted values within the numerical range are also applicable.

In an example, the third stage is conducted for 0.3 h to 2 h, for example, 0.3 h, 0.5 h, 0.7 h, 1 h, 1.2 h, 1.5 h, 1.8 h, or 2 h, but is not limited to the listed values, and other unlisted values within the numerical range are also applicable.

In the example of the present disclosure, the microwave heating is divided into three stages in which the temperature rises successively. Since the sulfuric acid reduction reaction is greatly affected by temperature and the microwave heating speed is high, a temperature control accuracy is difficult to grasp. Therefore, the reaction rate can be effectively controlled by segmented heating.

In an example, the microwave heating in step (2) is conducted at a power of 20 W/kg to 500 W/Kg, for example, 20 W/Kg, 50 W/Kg, 80 W/Kg, 100 W/Kg, 150 W/Kg, 200 W/Kg, 300 W/Kg, 400 W/Kg, or 500 W/Kg, but is not limited to the listed values, and other unlisted values within the numerical range are also applicable.

The setting of the microwave heating power is related to the amount of the reaction raw materials used. An increase in the amount of the raw materials causes the microwave heating power to increase accordingly.

In an example, the reaction in step (2) is conducted at an absolute pressure less than or equal to 99 kPa, for example, 99 kPa, 95 kPa, 90 kPa, 85 kPa, 80 kPa, 70 kPa, 50 kPa, 30 kPa, 20 kPa or 10 kPa, but is not limited to the listed values, and other unlisted values within the numerical range are also applicable.

In an example, the reaction in step (2) is conducted in a closed environment or a protective atmosphere, and a gas used in the protective atmosphere includes any one of an inert gas, nitrogen, and carbon dioxide, or a combination of two or more thereof. Typical but non-limiting combinations include a combination of an inert gas and nitrogen, a combination of nitrogen and carbon dioxide, a combination of an inert gas and carbon dioxide, or a combination of an inert gas, nitrogen, and carbon dioxide.

In an example, the sulfur dioxide gas obtained in step (2) is sent into a purification device via a blower to obtain a purified sulfur dioxide gas.

In the present disclosure, the sulfur dioxide prepared by the carbon reduction of waste sulfuric acid is extracted by a fan and sent to a purification device for purification to obtain purified sulfur dioxide; and the purified sulfur dioxide can be further prepared into sulfur trioxide or sulfuric acid.

In an example, the purification device includes an absorption purification tower.

In an example, the sulfur dioxide gas obtained in step (2) is allowed to flow through the carbon material, the sulfur dioxide gas and the carbon material are subjected to second microwave heating to obtain a mixed gas, and the mixed gas is subjected to condensation and washing with water to obtain liquid sulfur.

In an example, the ceramic absorbing material is provided in a reactor for the second microwave heating.

In the present disclosure, the sulfur dioxide prepared by the carbon reduction of waste sulfuric acid can also enter a second microwave reactor to further react with the carbon material under microwave heating to prepare the sulfur.

In an example, the second microwave heating is conducted at 600° C. to 700° C., for example, 600° C., 620° C., 650° C., 680° C., or 700° C., but is not limited to the listed values, and other unlisted values within the numerical range are also applicable.

In an example, the temperature of the second microwave heating has a certain influence on the reaction of sulfur dioxide reduction to sulfur. If the heating temperature is too low, there is an extremely low reaction rate of sulfur dioxide reduction to sulfur, resulting in a low efficiency; if the heating temperature is too high, the reaction is faster, but the amount of side reaction products such as CS₂ generated increases, resulting in a decrease in the sulfur yield. Therefore, the temperature of the second microwave heating is controlled within a preferred range.

In an example, the second microwave heating is conducted at a gas space velocity of (100-5,000) h⁻¹, for example, 100 h⁻¹, 300 h⁻¹, 500 h⁻¹, 800 h⁻¹, 1,000 h⁻¹, 1,500 h⁻¹, 2,000 h⁻¹, 2,500 h⁻¹, 3,000 h⁻¹, 3,500 h⁻¹, 4,000 h⁻¹, 4,500 h⁻¹, or 5,000 h⁻¹, but is not limited to the listed values, and other unlisted values within the numerical range are also applicable.

In an example, a non-condensable gas in the mixed gas enters a tail gas incineration device.

In an example, the non-condensable gas includes any one of COS, CS₂, H₂S, or CO, or a combination of two or more thereof. Typical but non-limiting combinations include a combination of COS and CS₂, a combination of H₂S and CO, a combination of COS, CS₂, and H₂S, a combination of CS₂, H₂S, and CO, or a combination of COS, CS₂, H₂S, and CO.

The sulfonated carbon obtained in step (2) can be used as a reaction raw material to repeatedly reduce waste sulfuric acid, thereby realizing resource recycling.

As a preferred technical solution of the present disclosure, the method for carbon reduction of waste sulfuric acid includes the following steps:
(1) immersing a carbon material with waste sulfuric acid to obtain a mixture; and
the sulfuric acid in the waste sulfuric acid has a mass concentration greater than or equal to 50 wt %; the sulfuric acid in the alkylated waste sulfuric acid has a mass concentration greater than or equal to 85 wt % when the waste sulfuric acid is the alkylated waste sulfuric acid; the sulfuric acid in the sulfonated waste sulfuric acid has a mass concentration greater than or equal to 85 wt % when the waste sulfuric acid is the sulfonated waste sulfuric acid; the waste sulfuric acid and the carbon material are at a mass ratio of (2-20):1; and the carbon material has a particle size less than or equal to 80 mm;
(2) subjecting the mixture obtained in step (1) to microwave heating at a power of 20 W/kg to 500 W/Kg under an absolute pressure less than or equal to 99 kPa to allow the reaction to obtain the sulfur dioxide gas and the sulfonated carbon; where the microwave heating includes the first stage, the second stage, and the third stage with temperatures rising sequentially; and
the first stage is conducted at 90° C. to 150° C. for 0.5 h to 3 h; the second stage is conducted at 160° C. to 220° C. for 0.5 h to 3 h; and the third stage is conducted at 230° C. to 300° C. for 0.3 h to 2 h; and
(3) sending the sulfur dioxide gas obtained in step (2) into the purification device through the blower to obtain the purified sulfur dioxide gas; alternatively, allowing the sulfur dioxide gas obtained in step (2) to flow through the carbon material at a gas space velocity of (100-5,000) h⁻¹, subjecting the sulfur dioxide gas and the carbon material to the second microwave heating at 600° C. to 700° C. to obtain the mixed gas, and subjecting the mixed gas to condensation and washing with water to obtain the liquid sulfur.

The present application has the following beneficial effects:
(1) In the present disclosure, the method for microwave-enhanced carbon reduction of waste sulfuric acid controls a reaction temperature of carbon and waste sulfuric acid by indirect heating through microwave radiation, and adopts a reasonable ratio of carbon material to waste sulfuric acid to effectively improve a reaction efficiency. The method has few reaction steps and low energy consumption, and can achieve low-cost resource utilization of waste sulfuric acid. The obtained sulfonated carbon can also be reused as a reaction raw material.
(2) In the present disclosure, a three-stage temperature-controlled microwave heating system can promote the full progress of the reaction at each stage. At the same time, the pretreated carbon material and the ceramic absorbing material with both absorbing and heat storage functions are combined to significantly improve the yield of the obtained reaction product.
(3) In the present disclosure, purified sulfur dioxide can be prepared by carbon reduction of waste sulfuric acid, and liquid sulfur can also be obtained by further reactions. The sulfur dioxide has a yield of up to 97%, and the sulfur has a yield of up to 95%, thereby realizing the multipolar recycling of waste sulfuric acid.

Other aspects of the present disclosure are understandable upon reading and understanding of the detailed description.

### DETAILED DESCRIPTION OF THE EMBODIMENTS

The technical solutions of the present application will be further described below through specific examples. Those skilled in the art should understand that these examples only help understand the present application and should not be regarded as specific limitations to the present application.

### Example 1

This example provided a method for microwave-enhanced carbon reduction of waste sulfuric acid, including the following steps:
(1) activated carbon was immersed with alkylated waste sulfuric acid to obtain a mixture;
the mixture was immersed in a mixed solution of sodium hydroxide and sodium carbonate at 60° C. for 5 h; sulfuric acid in the alkylated waste sulfuric acid had a mass concentration of 91 wt %; the alkylated waste sulfuric acid and the activated carbon were at a mass ratio of 10:1; and the activated carbon had a particle size less than or equal to 80 mm;
(2) the mixture obtained in step (1) was subjected to microwave heating at a power of 50 W/Kg under an absolute pressure of 90 kPa to allow a reaction to obtain a sulfur dioxide gas and sulfonated carbon; where the microwave heating includes a first stage, a second stage, and a third stage with temperatures rising sequentially; and
the first stage was conducted at 120° C. for 1.5 h; the second stage was conducted at 200° C. for 1.5 h; and the third stage was conducted at 280° C. for 1.2 h; and
(3) the sulfur dioxide gas in step (2) was sent to a purification tower via a blower to obtain purified sulfur dioxide.

The sulfur dioxide was absorbed by alkali and a sulfite content in the absorption liquid was measured, and the sulfur dioxide had a yield of 96%.

### Example 2

This example provided a method for microwave-enhanced carbon reduction of waste sulfuric acid, including the following steps:
(1) activated carbon was immersed with alkylated waste sulfuric acid to obtain a mixture;
the mixture was immersed in a mixed solution of sodium hydroxide and sodium carbonate at 75° C. for 3 h; sulfuric acid in the alkylated waste sulfuric acid had a mass concentration of 90 wt %; the alkylated waste sulfuric acid and the activated carbon were at a mass ratio of 5:1; and the activated carbon had a particle size less than or equal to 80 mm;
(2) the mixture obtained in step (1) was subjected to microwave heating at a power of 50 W/Kg under an absolute pressure of 95 kPa to allow a reaction to obtain a sulfur dioxide gas and sulfonated carbon; where the microwave heating includes a first stage, a second stage, and a third stage with temperatures rising sequentially; and
the first stage was conducted at 135° C. for 1 h; the second stage was conducted at 210° C. for 1 h; and the third stage was conducted at 260° C. for 1.5 h; and
(3) the sulfur dioxide gas in step (2) was sent to a purification tower via a blower to obtain purified sulfur dioxide.

The sulfur dioxide was absorbed by alkali and a sulfite content in the absorption liquid was measured, and the sulfur dioxide had a yield of 87%.

### Example 3

This example provided a method for microwave-enhanced carbon reduction of waste sulfuric acid, including the following steps:
(1) activated carbon was immersed with alkylated waste sulfuric acid to obtain a mixture;
the mixture was immersed in a mixed solution of sodium hydroxide and sodium carbonate at 45° C. for 7 h; sulfuric acid in the alkylated waste sulfuric acid had a mass concentration of 88 wt %; the alkylated waste sulfuric acid and the activated carbon were at a mass ratio of 15:1; and the activated carbon had a particle size less than or equal to 80 mm;
(2) the mixture obtained in step (1) was subjected to microwave heating at a power of 50 W/Kg under an absolute pressure of 85 kPa to allow a reaction to obtain a sulfur dioxide gas and sulfonated carbon; where the microwave heating includes a first stage, a second stage, and a third stage with temperatures rising sequentially; and
the first stage was conducted at 105° C. for 2 h; the second stage was conducted at 180° C. for 2 h; and the third stage was conducted at 290° C. for 0.7 h; and
(3) the sulfur dioxide gas in step (2) was sent to a purification tower via a blower to obtain purified sulfur dioxide.

The sulfur dioxide was absorbed by alkali and a sulfite content in the absorption liquid was measured, and the sulfur dioxide had a yield of 90%.

### Example 4

This example provided a method for microwave-enhanced carbon reduction of waste sulfuric acid, including the following steps:
(1) activated carbon was immersed with alkylated waste sulfuric acid to obtain a mixture;
the mixture was immersed in a mixed solution of sodium hydroxide and sodium carbonate at 90° C. for 1 h; sulfuric acid in the alkylated waste sulfuric acid had a mass concentration of 95 wt %; the alkylated waste sulfuric acid and the activated carbon were at a mass ratio of 20:1; and the activated carbon had a particle size less than or equal to 80 mm;
(2) the mixture obtained in step (1) was subjected to microwave heating at a power of 50 W/Kg under an absolute pressure of 80 kPa to allow a reaction to obtain a sulfur dioxide gas and sulfonated carbon; where the microwave heating includes a first stage, a second stage, and a third stage with temperatures rising sequentially; and
the first stage was conducted at 150° C. for 0.5 h; the second stage was conducted at 220° C. for 0.5 h; and the third stage was conducted at 300° C. for 0.3 h; and
(3) the sulfur dioxide gas in step (2) was sent to a purification tower via a blower to obtain purified sulfur dioxide.

The sulfur dioxide was absorbed by alkali and a sulfite content in the absorption liquid was measured, and the sulfur dioxide had a yield of 92%.

### Example 5

This example provided a method for microwave-enhanced carbon reduction of waste sulfuric acid, including the following steps:
(1) activated carbon was immersed with alkylated waste sulfuric acid to obtain a mixture;
the mixture was immersed in a mixed solution of sodium hydroxide and sodium carbonate at 30° C. for 9 h; sulfuric acid in the alkylated waste sulfuric acid had a mass concentration of 85 wt %; the alkylated waste sulfuric acid and the activated carbon were at a mass ratio of 2:1; and the activated carbon had a particle size less than or equal to 80 mm;
(2) the mixture obtained in step (1) was subjected to microwave heating at a power of 50 W/Kg under an absolute pressure of 99 kPa to allow a reaction to obtain a sulfur dioxide gas and sulfonated carbon; where the microwave heating includes a first stage, a second stage, and a third stage with temperatures rising sequentially; and
the first stage was conducted at 90° C. for 3 h; the second stage was conducted at 160° C. for 3 h; and the third stage was conducted at 230° C. for 2 h; and
(3) the sulfur dioxide gas in step (2) was sent to a purification tower via a blower to obtain purified sulfur dioxide.

The sulfur dioxide was absorbed by alkali and a sulfite content in the absorption liquid was measured, and the sulfur dioxide had a yield of 74%.

### Example 6

This example provided a method for microwave-enhanced carbon reduction of waste sulfuric acid, which was differed from Example 1 in that the activated carbon was replaced with biomass (rice husk) in equal mass, and the remaining steps were the same as those in Example 1.

The sulfur dioxide was absorbed by alkali and a sulfite content in the absorption liquid was measured, and the sulfur dioxide had a yield of 95%.

### Example 7

This example provided a method for microwave-enhanced carbon reduction of waste sulfuric acid, which was differed from Example 1 in that the mixture of activated carbon and silicon carbide was immersed with alkylated waste sulfuric acid, where the silicon carbide and the activated carbon were at a mass ratio of 0.1:1 in step (1), and the remaining steps were the same as those in Example 1.

The sulfur dioxide was absorbed by alkali and a sulfite content in the absorption liquid was measured, and the sulfur dioxide had a yield of 96.5%.

### Example 8

This example provided a method for microwave-enhanced carbon reduction of waste sulfuric acid, which was differed from Example 1 in that the mixture of activated carbon and silicon carbide was immersed with alkylated waste sulfuric acid, where the silicon carbide and the activated carbon were at a mass ratio of 10:1 in step (1), and the remaining steps were the same as those in Example 1.

The sulfur dioxide was absorbed by alkali and a sulfite content in the absorption liquid was measured, and the sulfur dioxide had a yield of 97%.

### Example 9

This example provided a method for microwave-enhanced carbon reduction of waste sulfuric acid, which was differed from Example 1 in that the microwave heating was continuously conducted to 280° C. within 4.2 h, and the remaining steps were the same as those in Example 1.

The sulfur dioxide was absorbed by alkali and a sulfite content in the absorption liquid was measured, and the sulfur dioxide had a yield of 86%. Compared with segmented heating, the continuous heating used in this example caused a lag in the temperature rise of the reaction materials after absorbing the wave, thus affecting the temperature control. Meanwhile, the microwave was frequently turned on and off, reducing a service life of the microwave reactor.

### Example 10

This example provided a method for microwave-enhanced carbon reduction of waste sulfuric acid, which was differed from Example 1 in that the microwave heating included a first stage and a second stage, where the first stage was conducted at 120° C. for 2.1 h, and the second stage was conducted at 200° C. for 2.1 h, and the remaining steps were the same as those in Example 1.

The sulfur dioxide was absorbed by alkali and a sulfite content in the absorption liquid was measured, and the sulfur dioxide had a yield of 91%. When an end temperature of microwave heating was 200° C., a reaction efficiency of the carbon reduction of the waste sulfuric acid decreased, resulting in a decrease in the yield of sulfur dioxide.

### Example 11

This example provided a method for microwave-enhanced carbon reduction of waste sulfuric acid, which was differed from Example 1 in that the mixture was not pretreated, and the remaining steps were the same as those in Example 1.

The sulfur dioxide was absorbed by alkali and a sulfite content in the absorption liquid was measured, and the sulfur dioxide had a yield of 93%. The activated carbon was not pretreated such that the effect of reacting with the waste sulfuric acid was relatively reduced.

### Example 12

This example provided a method for microwave-enhanced carbon reduction of waste sulfuric acid, which was differed from Example 1 in that step (3): the sulfur dioxide gas obtained in step (2) was allowed to flow through the activated carbon and silicon carbide at a gas space velocity of 1,000 h⁻¹, the sulfur dioxide gas and the activated carbon and silicon carbide were subjected to second microwave heating at 700° C. to obtain a mixed gas, and the mixed gas was subjected to condensation and washing with water to obtain liquid sulfur, and the remaining steps were the same as those in Example 1.

The liquid sulfur had a yield of 95%.

### Example 13

This example provided a method for microwave-enhanced carbon reduction of waste sulfuric acid, which was differed from Example 12 in that the second microwave heating was conducted at 650° C., and the remaining steps were the same as those in Example 12.

The liquid sulfur had a yield of 88%.

### Example 14

This example provided a method for microwave-enhanced carbon reduction of waste sulfuric acid, which was differed from Example 12 in that the second microwave heating was conducted at 600° C., and the remaining steps were the same as those in Example 12.

The liquid sulfur had a yield of 84%.

### Example 15

This example provided a method for microwave-enhanced carbon reduction of waste sulfuric acid, which was differed from Example 12 in that the gas space velocity was 100 h⁻¹, and the remaining steps were the same as those in Example 12.

The liquid sulfur had a yield of 91%. When the space velocity was too low, a material residence time might be longer, affecting the processing volume and having an adverse effect on the reactants. Therefore, the space velocity should not be too low.

### Example 16

This example provided a method for microwave-enhanced carbon reduction of waste sulfuric acid, which was differed from Example 12 in that the gas space velocity was 5,000 h⁻¹, and the remaining steps were the same as those in Example 12.

The liquid sulfur had a yield of 81%. When the space velocity was too high, the material residence time was short, such that the reaction was not conducted sufficiently, causing a reduction in the yield of product.

### Example 17

This example provided a method for microwave-enhanced carbon reduction of waste sulfuric acid, which was differed from Example 12 in that the second microwave heating was conducted at 550° C., and the remaining steps were the same as those in Example 12.

The liquid sulfur had a yield of 74%. If the heating temperature was too low, the reaction rate of reducing sulfur dioxide to sulfur might be extremely slow, thus reducing the reaction efficiency.

### Example 18

This example provided a method for microwave-enhanced carbon reduction of waste sulfuric acid, which was differed from Example 12 in that the second microwave heating was conducted at 750° C., and the remaining steps were the same as those in Example 12.

The liquid sulfur had a yield of 85%. Heating at too high a temperature resulted in a faster reaction, but the amount of side reaction products such as CS₂ increased, leading to a decrease in sulfur production.

### Comparative Example 1

This comparative example provided a method for microwave-enhanced carbon reduction of waste sulfuric acid, which was differed from Example 1 in that the microwave heating was replaced by oil bath heating, and the remaining steps were the same as those in Example 1.

The sulfur dioxide had a yield of 78%. The temperature of a reaction interface between the activated carbon and the waste sulfuric acid increased under microwave heating, which was beneficial to the reaction; while oil bath heating was slow and less efficient than the microwave heating, resulting in a decrease in the yield of the product.

In summary, the method for microwave-enhanced carbon reduction of waste sulfuric acid controls a reaction temperature of carbon and waste sulfuric acid by indirect heating through microwave radiation, and adopts a reasonable ratio of carbon material to waste sulfuric acid to effectively improve a reaction efficiency. The method has few reaction steps and low energy consumption, and can achieve low-cost resource utilization of waste sulfuric acid. A three-stage temperature-controlled microwave heating system can promote the full progress of the reaction at each stage. At the same time, the pretreated carbon material and the ceramic absorbing material with both absorbing and heat storage functions are combined to significantly improve the yield of the obtained reaction product. The purified sulfur dioxide can be prepared by carbon reduction of waste sulfuric acid, and liquid sulfur can also be obtained by further reactions. The sulfur dioxide has a yield of up to 97%, and the sulfur has a yield of up to 95%, thereby realizing the multipolar recycling of waste sulfuric acid.

The above are merely specific implementations of the present application, and the protection scope of the present application is not limited thereto. Those skilled in the art should understand that any modification or replacement easily conceived by those skilled in the art within the technical scope of the present application should fall within the protection scope and disclosure scope of the present application.

1. A method for microwave-enhanced carbon reduction of waste sulfuric acid, comprising the following steps:
(1) immersing a carbon material with waste sulfuric acid to obtain a mixture; and
(2) subjecting the mixture obtained in step (1) to microwave heating to allow a reaction to obtain a sulfur dioxide gas and sulfonated carbon.

2. The method according to claim 1, wherein the carbon material in step (1) is any one or a combination of two or more selected from the group consisting of coal, biomass, activated carbon, resin, sulfonated carbon, biochar, waste activated carbon, and waste resin; and
optionally, the waste sulfuric acid in step (1) is any one or a combination of two or more selected from the group consisting of alkylated waste sulfuric acid, sulfonated waste sulfuric acid, nitrated waste sulfuric acid, and fluorine-containing waste sulfuric acid.

3. The method according to claim 1, wherein the carbon material in step (1) is obtained by pretreatment with a mixture of an alkali and a carbonate;
optionally, the mixture of the alkali and the carbonate comprises a mixture of sodium hydroxide and sodium carbonate;
optionally, the pretreatment is conducted for 0.1 h to 9 h; and
optionally, the pretreatment is conducted at 30° C. to 90° C.

4. The method according to claim 1, wherein sulfuric acid in the waste sulfuric acid in step (1) has a mass concentration greater than or equal to 50 wt %;
optionally, the sulfuric acid in the alkylated waste sulfuric acid has a mass concentration greater than or equal to 85 wt % when the waste sulfuric acid is the alkylated waste sulfuric acid;
optionally, the sulfuric acid in the sulfonated waste sulfuric acid has a mass concentration greater than or equal to 85 wt % when the waste sulfuric acid is the sulfonated waste sulfuric acid; and
optionally, the waste sulfuric acid and the carbon material in step (1) are at a mass ratio of (2-20):1;
optionally, the carbon material in step (1) has a particle size less than or equal to 80 mm.

5. The method according to claim 1, wherein the mixture in step (1) further comprises a ceramic absorbing material;
optionally, the ceramic absorbing material is any one or a combination of two or more selected from the group consisting of silicon carbide, aluminum oxide, silicon dioxide, silicon nitride, and a ferric oxide composite ceramic;
optionally, the ceramic absorbing material and the carbon material are at a mass ratio of (0.1-10):1; and
optionally, the mixture in step (1) is obtained by separating excess waste sulfuric acid.

6. The method according to claim 1, wherein the microwave heating in step (2) comprises a first stage, a second stage, and a third stage with temperatures rising sequentially; and
optionally, the first stage is conducted at 90° C. to 150° C. for 0.5 h to 3 h;
optionally, the second stage is conducted at 160° C. to 220° C. for 0.5 h to 3 h;
optionally, the third stage is conducted at 230° C. to 300° C. for 0.3 h to 2 h; and
optionally, the microwave heating in step (2) is conducted at a power of 20 W/kg to 500 W/Kg.

7. The method according to claim 1, wherein the reaction in step (2) is conducted at an absolute pressure less than or equal to 99 kPa; and
optionally, the reaction in step (2) is conducted in a closed environment or a protective atmosphere, and a gas used in the protective atmosphere is any one or a combination of two or more selected from the group consisting of an inert gas, nitrogen, and carbon dioxide.

8. The method according to claim 1, wherein the sulfur dioxide gas obtained in step (2) is sent into a purification device via a blower to obtain a purified sulfur dioxide gas;
optionally, the purification device comprises an absorption purification tower;
optionally, the sulfur dioxide gas obtained in step (2) is allowed to flow through the carbon material, the sulfur dioxide gas and the carbon material are subjected to second microwave heating to obtain a mixed gas, and the mixed gas is subjected to condensation and washing with water to obtain liquid sulfur; and
optionally, the ceramic absorbing material is provided in a reactor for the second microwave heating.

9. The method according to claim 8, wherein the second microwave heating is conducted at 600° C. to 700° C.;
optionally, the second microwave heating is conducted at a gas space velocity of (100-5,000) h⁻¹; and
optionally, a non-condensable gas in the mixed gas enters a tail gas incineration device.

10. The method according to claim 1, comprising the following steps:
(1) immersing the carbon material with the waste sulfuric acid to obtain the mixture; wherein
the sulfuric acid in the waste sulfuric acid has a mass concentration greater than or equal to 50 wt %; the sulfuric acid in the alkylated waste sulfuric acid has a mass concentration greater than or equal to 85 wt % when the waste sulfuric acid is the alkylated waste sulfuric acid; the sulfuric acid in the sulfonated waste sulfuric acid has a mass concentration greater than or equal to 85 wt % when the waste sulfuric acid is the sulfonated waste sulfuric acid; the waste sulfuric acid and the carbon material are at a mass ratio of (2-20):1; and the carbon material has a particle size less than or equal to 80 mm;
(2) subjecting the mixture obtained in step (1) to the microwave heating at a power of 20 W/kg to 500 W/Kg under an absolute pressure less than or equal to 99 kPa to allow the reaction to obtain the sulfur dioxide gas and the sulfonated carbon; wherein the microwave heating comprises the first stage, the second stage, and the third stage with temperatures rising sequentially; and
the first stage is conducted at 90° C. to 150° C. for 0.5 h to 3 h; the second stage is conducted at 160° C. to 220° C. for 0.5 h to 3 h; and the third stage is conducted at 230° C. to 300° C. for 0.3 h to 2 h; and
(3) sending the sulfur dioxide gas obtained in step (2) into the purification device through the blower to obtain the purified sulfur dioxide gas; alternatively, allowing the sulfur dioxide gas obtained in step (2) to flow through the carbon material at a gas space velocity of (100-5,000) h⁻¹, subjecting the sulfur dioxide gas and the carbon material to the second microwave heating at 600° C. to 700° C. to obtain the mixed gas, and subjecting the mixed gas to the condensation and the washing with water to obtain the liquid sulfur.

11. The method according to claim 2, wherein the carbon material in step (1) is obtained by pretreatment with a mixture of an alkali and a carbonate;
optionally, the mixture of the alkali and the carbonate comprises a mixture of sodium hydroxide and sodium carbonate;
optionally, the pretreatment is conducted for 0.1 h to 9 h; and
optionally, the pretreatment is conducted at 30° C. to 90° C.

12. The method according to claim 2, wherein sulfuric acid in the waste sulfuric acid in step (1) has a mass concentration greater than or equal to 50 wt %;
optionally, the sulfuric acid in the alkylated waste sulfuric acid has a mass concentration greater than or equal to 85 wt % when the waste sulfuric acid is the alkylated waste sulfuric acid;
optionally, the sulfuric acid in the sulfonated waste sulfuric acid has a mass concentration greater than or equal to 85 wt % when the waste sulfuric acid is the sulfonated waste sulfuric acid; and
optionally, the waste sulfuric acid and the carbon material in step (1) are at a mass ratio of (2-20):1;
optionally, the carbon material in step (1) has a particle size less than or equal to 80 mm.

13. The method according to claim 3, wherein sulfuric acid in the waste sulfuric acid in step (1) has a mass concentration greater than or equal to 50 wt %;
optionally, the sulfuric acid in the alkylated waste sulfuric acid has a mass concentration greater than or equal to 85 wt % when the waste sulfuric acid is the alkylated waste sulfuric acid;
optionally, the sulfuric acid in the sulfonated waste sulfuric acid has a mass concentration greater than or equal to 85 wt % when the waste sulfuric acid is the sulfonated waste sulfuric acid; and
optionally, the waste sulfuric acid and the carbon material in step (1) are at a mass ratio of (2-20):1;
optionally, the carbon material in step (1) has a particle size less than or equal to 80 mm.

14. The method according to claim 2, wherein the mixture in step (1) further comprises a ceramic absorbing material;
optionally, the ceramic absorbing material is any one or a combination of two or more selected from the group consisting of silicon carbide, aluminum oxide, silicon dioxide, silicon nitride, and a ferric oxide composite ceramic;
optionally, the ceramic absorbing material and the carbon material are at a mass ratio of (0.1-10):1; and
optionally, the mixture in step (1) is obtained by separating excess waste sulfuric acid.

15. The method according to claim 3, wherein the mixture in step (1) further comprises a ceramic absorbing material;
optionally, the ceramic absorbing material is any one or a combination of two or more selected from the group consisting of silicon carbide, aluminum oxide, silicon dioxide, silicon nitride, and a ferric oxide composite ceramic;
optionally, the ceramic absorbing material and the carbon material are at a mass ratio of (0.1-10):1; and
optionally, the mixture in step (1) is obtained by separating excess waste sulfuric acid.

16. The method according to claim 4, wherein the mixture in step (1) further comprises a ceramic absorbing material;
optionally, the ceramic absorbing material is any one or a combination of two or more selected from the group consisting of silicon carbide, aluminum oxide, silicon dioxide, silicon nitride, and a ferric oxide composite ceramic;
optionally, the ceramic absorbing material and the carbon material are at a mass ratio of (0.1-10):1; and
optionally, the mixture in step (1) is obtained by separating excess waste sulfuric acid.

17. The method according to claim 2, wherein the microwave heating in step (2) comprises a first stage, a second stage, and a third stage with temperatures rising sequentially; and
optionally, the first stage is conducted at 90° C. to 150° C. for 0.5 h to 3 h;
optionally, the second stage is conducted at 160° C. to 220° C. for 0.5 h to 3 h;
optionally, the third stage is conducted at 230° C. to 300° C. for 0.3 h to 2 h; and
optionally, the microwave heating in step (2) is conducted at a power of 20 W/kg to 500 W/Kg.

18. The method according to claim 3, wherein the microwave heating in step (2) comprises a first stage, a second stage, and a third stage with temperatures rising sequentially; and
optionally, the first stage is conducted at 90° C. to 150° C. for 0.5 h to 3 h;
optionally, the second stage is conducted at 160° C. to 220° C. for 0.5 h to 3 h;
optionally, the third stage is conducted at 230° C. to 300° C. for 0.3 h to 2 h; and
optionally, the microwave heating in step (2) is conducted at a power of 20 W/kg to 500 W/Kg.

19. The method according to claim 4, wherein the microwave heating in step (2) comprises a first stage, a second stage, and a third stage with temperatures rising sequentially; and
optionally, the first stage is conducted at 90° C. to 150° C. for 0.5 h to 3 h;
optionally, the second stage is conducted at 160° C. to 220° C. for 0.5 h to 3 h;
optionally, the third stage is conducted at 230° C. to 300° C. for 0.3 h to 2 h; and
optionally, the microwave heating in step (2) is conducted at a power of 20 W/kg to 500 W/Kg.

20. The method according to claim 5, wherein the microwave heating in step (2) comprises a first stage, a second stage, and a third stage with temperatures rising sequentially; and
optionally, the first stage is conducted at 90° C. to 150° C. for 0.5 h to 3 h;
optionally, the second stage is conducted at 160° C. to 220° C. for 0.5 h to 3 h;
optionally, the third stage is conducted at 230° C. to 300° C. for 0.3 h to 2 h; and
optionally, the microwave heating in step (2) is conducted at a power of 20 W/kg to 500 W/Kg.
